(19) United States
(12) Patent Application Publication
(10) Pub. No.: US 2023/0394609 A1
(43) Pub. Date: Dec. 7, 2023

(54) MACHINE LEARNING SERVICE BASED ON SKILLS GRAPH

(71) Applicant: Steady Platform LLC, Atlanta, GA (US)

(72) Inventors: Jason Robinson, Atlanta, GA (US); Tyler Howard, Atlanta, GA (US); Amanda Miguel, Atlanta, GA (US); Thaddeus Gholston, Atlanta, GA (US); Adam Roseman, Atlanta, GA (US)

(21) Appl. No.: 18/327,943

(22) Filed: Jun. 2, 2023

Related U.S. Application Data
(60) Provisional application No. 63/348,111, filed on Jun. 2, 2022.

(51) Int. Cl. G06Q 50/20; G06Q 10/0631; G06Q 10/0639

(52) U.S. Cl. CPC G06Q 50/2057; G06Q 10/06398; G06Q 10/063112

(57) ABSTRACT

Provided are systems and methods for recommending and prioritizing jobs to pursue, as well as skills, credentials, education, and the like to obtain, targeted to both individuals and consultants, coaches, etc. who may help those individuals. The prioritizing and the recommending may be performed based on a skills graph that includes nodes representing entities, and edges annotated with shared skills information between the entities. Thus, the skills graph can be used to find entities that are similar to each other in terms of skills.

### CROSS-REFERENCE TO RELATED APPLICATIONS

This application claims the benefit of U.S. Provisional Application No. 63/348,111, filed on Jun. 2, 2022, in the United States Patent and Trademark Office, the entire disclosure of which is incorporated herein by reference for all purposes.

### BACKGROUND

Employers often assess candidates for hiring based on their work history, education, skills, licenses, certifications, etc. In many cases, candidates may not know how best to match their skills and credentials against potential job roles. Furthermore, once in a role, a candidate may not understand how best to prepare for their next role in their career ladder (e.g., a series of lateral and upward moves, etc.). In many cases, a person in a particular role may not be aware of the best upskilling, credentialing, or other next steps to take to achieve their ideal next role, because they are unlikely to know how their skill set compares to the skills that are required for that next role. Moreover, a person may not know what skills would lead to higher financial returns on the investment in gaining those skills, how to sequence upskilling, credentialing, and other activities for the best payoff, etc. As a result, a person may never achieve their true potential, spending a lifetime in jobs that do not provide advancement opportunities, financial improvement, or job satisfaction.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1A is a diagram illustrating a host platform that is configured to generate a skills certificate and/or a set of skills, work types, or other relevant recommendations, in accordance with an example embodiment.

FIG. 1B is a diagram illustrating an example of the skills certificate that is created by the host platform in FIG. 1A, in accordance with an example embodiment.

FIG. 1C is a diagram illustrating an example of a recommendation that is created by the host platform in FIG. 1A, in accordance with an example embodiment.

FIGS. 2A-2D are diagrams illustrating a process of performing machine learning based on a skills graph in accordance with example embodiments.

FIGS. 3A-3D are diagrams illustrating a process of verifying skills via a blockchain platform in accordance with example embodiments.

FIG. 4 is a diagram illustrating a computing system capable of being used in any of the examples herein in accordance with an example embodiment.

FIG. 5 is a diagram illustrating a method generating a recommendation based on a skills graph in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, details are set forth to provide a reader with a thorough understanding of various example embodiments. It should be appreciated that modifications to the embodiments will be readily apparent to those skilled in the art, and generic principles defined herein may be applied to other embodiments and applications without departing from the spirit and scope of the disclosure. Moreover, in the following description, numerous details are set forth as an explanation. However, one of ordinary skill in the art should understand that embodiments may be practiced without the use of these specific details. In other instances, well-known structures and processes are not shown or described so as not to obscure the description with unnecessary detail. Thus, the present disclosure is not intended to be limited to the embodiments shown, but is to be accorded the widest scope consistent with the principles and features disclosed herein.

The example embodiments are directed to a host platform such as a web server, a cloud platform, a blockchain network, or the like, which can build a skills certificate for a user based on information provided by the user, and that skills certificate can subsequently be verified as authentic by the host platform. The skills certificate can be created in digital form with relevant skills, work experience, educational experience, licenses, certificates, etc. pre-populated within the document. The host platform may also add certifications into the document, such as signatures or other marks indicating which skills (and/or work experience, education, licenses, skills obtained, etc.) have been verified by the system, either directly or via external certification and credentialing services, or the like. The host platform may send the document to the user, for example, to a mobile application running on the user's mobile device. As another example, the host platform may attach the skills certificate to a message such as a SMS message or an email message and send the skills certificate via a message.

In some embodiments, the host platform may embody a machine learning service with machine learning models capable of recommending new positions of employment to users using machine learning and a graph data structure, which is referred to herein as a “skills graph”. The skills graph includes job types (e.g., delivery driver, food prep worker, bank teller, landscaper, and the like). The skills graph may include a plurality of nodes, which are interconnected to one another via edges. The skills graph may be a directed or undirected graph. Also, the skills graph is typically not built as a fully connected graph data structure, meaning that a given node is not typically connected to every other node via a pair of unique edges, but that a given node connects to a plurality of adjacent nodes. The nodes may represent the different job types, while the edges may be used to store/show the number of shared skill attributes between the different job types. In some implementations, there is a set of nodes that represent different job types, connected by edges to nodes that represent skills or skills clusters. Both nodes and edges may be unweighted or have weights or values associated with them, and those weights or values may represent monetary, commonality, importance, number of subcomponents, or other measures that could be useful within associated machine learning models.

The skills graph can be precomputed, cached, or generated “on-the-fly.” For example, the host platform may dynamically build the skills graph in response to a search request or job prediction request from the user. In this case, the user may submit a job type such as a job that they currently perform. The host platform assumes or may verify that the user has the requisite skills for such a job. In response, the host platform may identify a predefined list of skills assigned to the job type. The skills may be defined in advance and may be based on external data sources, etc. In some cases, the skills may be identified based on predefined skill codes defined by O*NET, however embodiments are not limited thereto.

The host platform may use the list of skills obtained for the submitted job type and search for other job types with similar skills. Here, the host may identify all other job types that share one or more skills in the common with the submitted job type, and create nodes for the job types. In some embodiments, the host may connect each node to a node that represents the submitted job type. The result is a graph of interconnected nodes where the nodes represent job types and the edges between the nodes represent shared skills. The skills graph may be designed/built by the example embodiments based on a graph database like Neo4J, graph capabilities in large-scale data processing engines like Apache Spark GraphX, or the like.

Additionally, in these and other embodiments, a physical or virtual (e.g. a chatbot) coach, could use output from machine learning and the skills graph to make recommendations to the user, take feedback from the user and/or coach, and determine impact on a user's income, based on user-reported information, automated payroll verification, and/or automated financial transaction analysis, generating reports and other relevant artefacts that show and can help improve recommendation performance.

As changes in the job market and the recent pandemic have caused a shift away from automatable jobs of the past and a shift towards more skills-based hiring, there is a need for a person interested in finding available employment to be able to quantify their experience beyond the traditional resume. The example embodiments are directed toward a skills certification process and skills-based recommendation engine, which may be used to verify a user's historical achievements including work history, education, payroll, skills obtained, and the like, and suggest next steps, including skills to obtain, for the user to be in a better position to obtain their ideal role, increase their potential for generating earnings, or otherwise improve their current employment situation and/or future career pathway. The host platform may ingest data related to previous or current jobs of the person to provide a list of skills that a given user is believed to possess based on market data, combined with verified employment history. Furthermore, based on a machine learning service, the system may recommend skills that the user should obtain to place themselves in a better place for their next role, increase their potential for generating earnings, or otherwise improve their current employment situation and/or future career pathway.

Some of the benefits of the system and process described herein include implementing a platform that can easily digest a skills list that can serve as an augmentation of or as an alternative to a resume or a cover letter for a user that is trying to search for a job. The system can help the user compile an applicable list of skills using existing work type and market-specific data, making the process easier for a worker who may not have the time or knowledge to compile their own lists.

The system can verify employment history, which may include both employee/W-2 employment as well as nontraditional or non-standard income, often in the form of 1099 wages. In addition, the system can output a document (e.g., a digital document such as a pdf document, a word processing document, a spreadsheet, a CSV file, an XML file, a JSON file, or the like) that is tailored to what employers are looking for or may be interested in from potential employees, as well as for guiding, promoting, and/or otherwise developing current employees who are considering their career progressions, as well as during performance review and management activities. The document may include a list of skills identified by the host platform and an indicator, such as a tag, signature, mark, or other content within the document that indicates which skills have been verified by the host platform, and which skills are unverified (or possibly just common knowledge in the art, etc.).

Some of the drawbacks addressed by the example embodiments include an automated document generation process, which creates a document that a person can take with them into a job interview or other employment opportunity to give (hand over) to prospective employers. The host platform may pre-populate the document with a list of skills of the person identified from the person's history and compile a list of skills in an organized fashion for the person. The host platform may also perform an employment verification which leverages a core technology of verifying income and employment history, even for the nonstandard or nontraditional worker. The system also provides a method by which to validate a user's skills. The validation can be certified by the host platform by creating a signature or other mark inside the document (skills certificate), which lets the employer know which skills have been verified by the host platform which in this case is an unbiased third-party.

The skills certification process may include the following steps, however the embodiments are not expressly limited hereto. Other steps may be performed, or steps listed below may not be performed. Also, the steps may be performed in a different order and some of the steps may be performed at the same time (i.e., simultaneously).
1. A user provides their work experience history.
2. The host platform compiles the user's work history and queries internal and/or external data sources for the skills that are commonly associated with those jobs (e.g., which are mapped to O*NET job codes, mapped to other relevant identifiers by employment data providers, associated with jobs via various government entities, etc.), based on user submitted/third-party/market level data.
3. Where applicable, the host platform may perform a validation to verify that those skills are held by the user. This validation can be achieved in several ways, including but not limited to the following:
   a. Surveys to determine the user's relevant experience.
      i. Short form questions or prompts, e.g., “Did you perform these skills at this job?”
      ii. Long form questions or prompts, e.g., “Describe the work that you performed that would highlight this particular skill.”
   b. Skills tests.
      i. Internal and/or external tests designed to assess the user's skills.
      ii. A summary of the user's responses and whether or not the user answered correctly may be included in the skills certification.
   c. External course verification before certification.
      i. The user can upload certification artefacts after course completion.
   d. The system can receive automated credentials directly from the course provider.
4. Unvalidated skills could be indicated as being commonly found based on market data but not verified.
5. The host platform may verify employment history related to each work type.
6. The host platform may compile the final skills list and verification information, which can be provided in various formats and delivery mechanisms, for example the following:
   a. Directly to the user in a report format for job-search processes
   b. To businesses, in individual or aggregate form
   c. To government entities, in individual or aggregate form
   d. To NGO entities, in individual or aggregate form
7. The system can store records of the user's past experience, test results, credentialing, and other relevant information and metadata, such as expiration dates, applicability, and the like, to streamline later verification and validation activities for the user.
   a. Relevant metadata related to the report can be written to an appropriate blockchain or trusted data store.
   b. The user, employers, and others can then query the system to check the authenticity of the output.

The platform described herein may perform the activities of the platforms described in U.S. patent application Ser. No. 17/968,855, filed on Oct. 19, 2022, in the United States Patent and Trademark Office, described in U.S. patent application Ser. No. 18/142,814, filed on May 3, 2023, in the United States Patent and Trademark Office, described in U.S. patent application Ser. No. 17/864,589, filed on Jul. 14, 2022, in the United States Patent and Trademark Office, described in U.S. patent application Ser. No. 17/342,622, filed on Jun. 9, 2021, in the United States Patent and Trademark Office, described in U.S. patent application Ser. No. 17/867,958, filed on Jul. 19, 2022, in the United States Patent and Trademark Office, described in U.S. patent application Ser. No. 17/580,721, filed on Jan. 21, 2022, in the United States Patent and Trademark Office, described in U.S. patent application Ser. No. 18/113,137, filed on Feb. 23, 2023, in the United States Patent and Trademark Office, and described in U.S. patent application Ser. No. 17/888,630, filed on Aug. 16, 2022, in the United States Patent and Trademark Office, the entire disclosures of each of which are incorporated herein by reference for all purposes and may be used with the example embodiments.

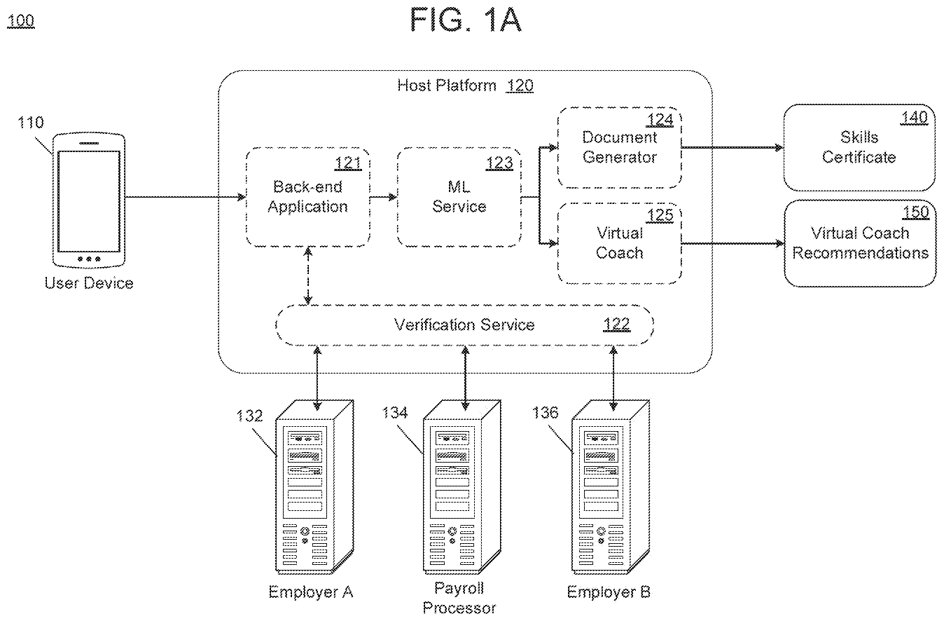

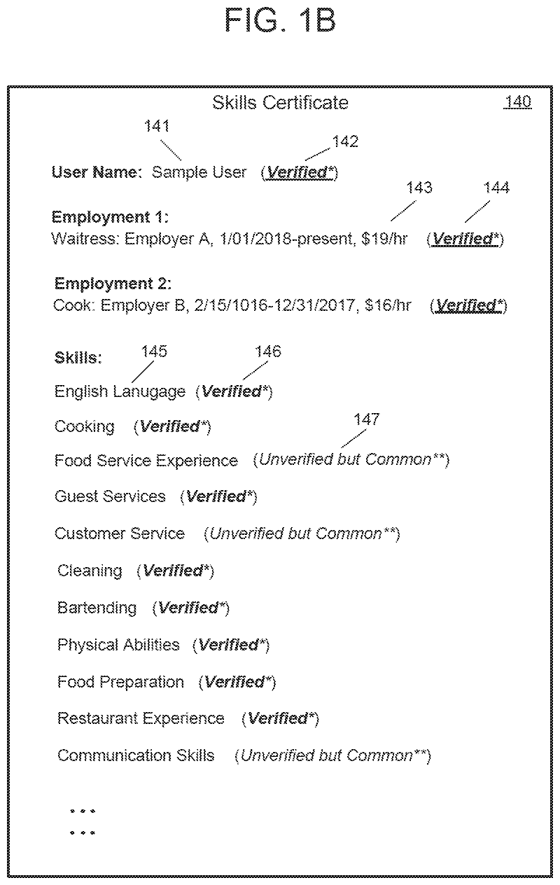

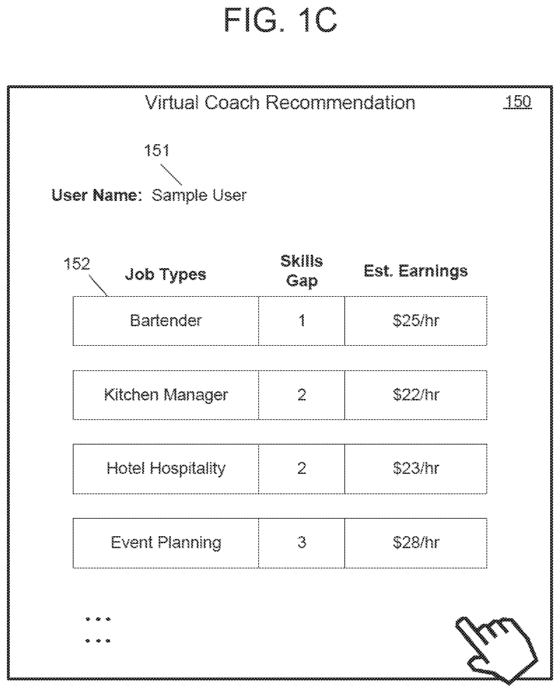

FIG. 1A illustrates a computing environment 100 that includes a host platform 120 that is configured to generate a skills certificate 140 in accordance with an example embodiment. The host platform 120 may be accessible via the Internet and may host a software application or a suite of applications, including, but not limited to, a mobile application, a web application (e.g., a progressive web application, etc.), a service, a group of services, an application programming interface (API) or multiple APIs, and the like. The host platform 120 may be a cloud platform, a web server, a database or collection of databases, a distributed network of devices such as a blockchain network, a combination of systems and/or networks, and the like.

Referring to FIG. 1A, a user may access the host platform 120 via a user device 110 and may connect to a URI or other IP address that contains application content hosted by the host platform. Here, the user device 110 may open a front-end of the software application (not shown) on a screen of the user device 110 which corresponds to a back-end application 121 installed and deployed on the host platform 120. The user may upload documents, images, content, certificates, transcripts, paystubs, W-2s, W-4s, 1099s, and the like to the back-end of the application 121 on the host platform 120. The host platform 120 may ingest the data and create a data record for the user. Each user may be assigned a unique identifier by the host platform 120 and the same identifier may be added to the data record created for the respective user. The data record may include a document, a file, a database table, or the like. As another example, the data record may be contained or held within a topic such as in a Kafka-based system.

The ingested data may be organized into a list of skills. In some embodiments, the host platform 120 may use predefined codes associated with a particular job type to figure out which skills are associated with the jobs the user has performed. For example, if the user submits information indicating they have experience as a waiter/waitress, then the host platform 120 may query an internal data store or a third-party data store (e.g., via an API, etc.) for O*NET (or similar) job codes associated with the particular job type. In this example, the query may return a set of skills such as the following:

```
Waiter/Waitress
[
    “English”
    “Cooking”
    “Food Service Experience”
    “Food Delivery”
    “Guest Services”
    “Cleaning”
    “Customer Service”
    “Physical Abilities”
    “Food Preparation”
    “Bartending”
    “Organizational Skills”
    “Communication Skills”
    “Restaurant Experience”
    “Teamwork / Collaboration”
]
```

This list may be returned by querying the internal data store with an identifier of a job type (e.g., waiter/waitress, etc.). In other words, the query may contain an identifier of the job type and the query results may include skills that are mapped to that job type by the O*NET system. The O*NET system may be accessed directly or downloaded to an internal data store of the host platform on a periodic basis (e.g., monthly, quarterly, etc.) based on when the O*NET system is updated, which can be on a quarterly basis.

The host platform 120 may include a verification service 122 that is capable of verifying or otherwise assessing whether or not the user has obtained the skills included in the O*NET job codes by establishing secure channels with external data sources such as a payroll processing server that holds payroll information of the user, an employer server which holds employment information of the user, a licensing agency, a certification agency, a testing agency or service, or the like. The verification service 122 may establish an authenticated channel with any of these outside sources such as an employer 132, a payroll processor 134, and a second employer 136 as shown in FIG. 1A.

The verification service 122 may create individual/separate communications channels using different authentications mechanisms of the respective sources (e.g., the employer 132, the payroll processor 134, and the second employer 136, etc.). For example, the verification service 122 may connect to and access different APIs of the different external data sources to establish the secure authenticated communication channels. In addition, the verification service 122 may query data files and records of the user via the established authentication channels to obtain information about the user that can be used to verify whether or not the user possesses the requisite skills associated with the job type.

In some embodiments, the host platform 120 may also include or be connected to a machine learning service 123 that includes one or more machine learning models for identifying information from the skills data and the validation/verification data. For example, the machine learning models may identify optimal or otherwise ranked or recommended job opportunities for a user based on other job functions and work types that are performed by other users in the community using the data that has been ingested. In some embodiments, the optimal, near optimal, and otherwise relevant job opportunity information may be output to the user via a mobile application, website, or the like. Information about the optimal, near optimal, and otherwise relevant job opportunities, including job titles, scheduling, average pay earned by others working such job opportunities, and the like, can be output through a visualization that is provided to the user.

The host platform 120 also includes a document generator 124, which is a service that can build a digital document (skills certificate 140) and populate the digital document with attributes of the user including identifiers of which attributes (e.g., skills, etc.) of the user have been externally verified by the host platform 120 and which attributes have not been verified. The digital document may be embodied in the form of a pdf file, a csv file, a JSON file, an XML file, or the like. The document itself may include human-readable descriptions of the user. The skills certificate 140 may be delivered to the user device 110 via a message or via the application itself. In addition, the host platform 120 may securely deliver the skills certificate to any other systems and employers that the user desires.

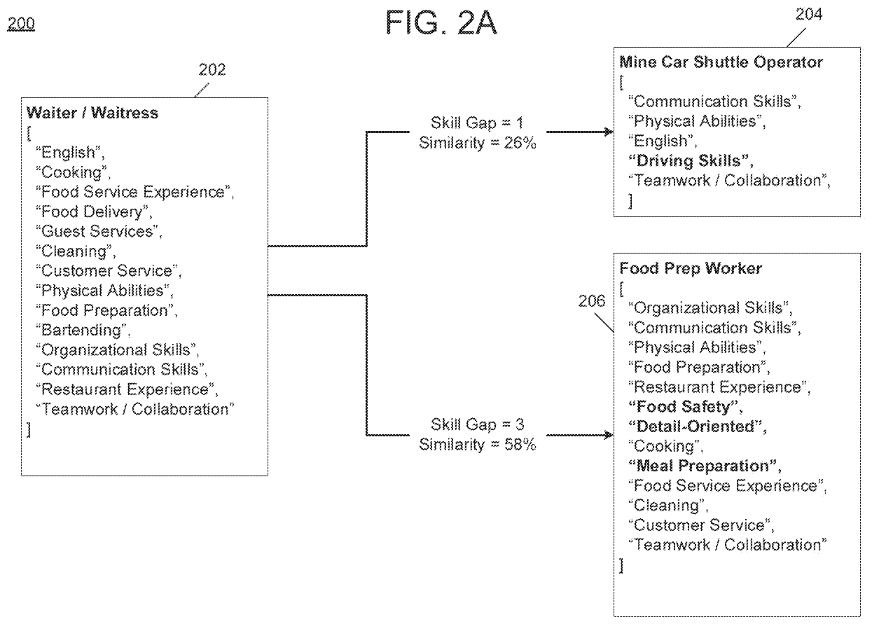

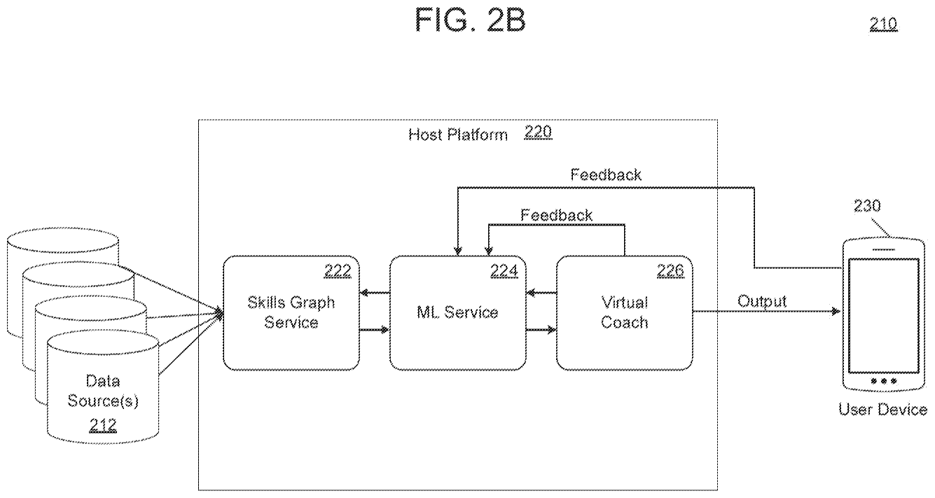

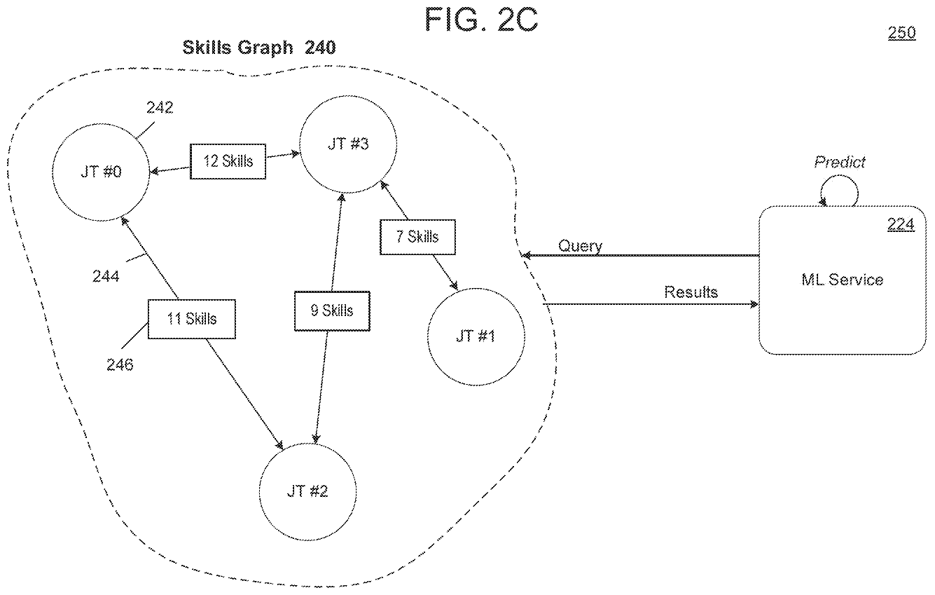

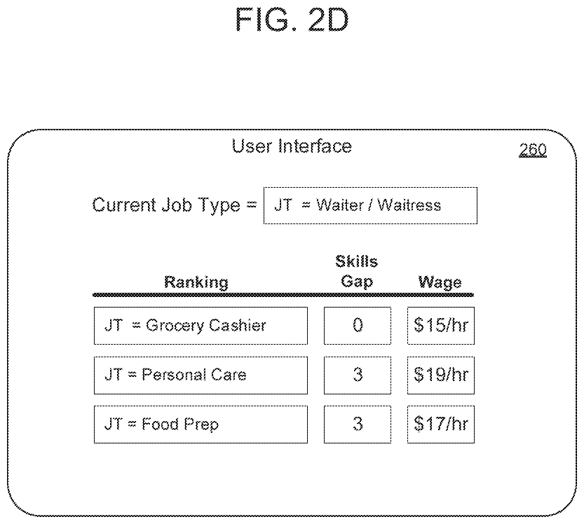

As another example, the host platform 120 may include a virtual coach 125 that may be embodied in the form of a chatbot service, or the like. The virtual coach 125 may provide skills recommendations to a user based on a skills graph that is also stored and managed by the host platform 120 as further described in the example of FIG. 2B. The virtual coach 125 may access the machine learning service 123 to request recommendations for the next skills of the user to obtain to advance along their career ladder. Also, input from the user via the chatbot or other user interface output by the virtual coach 125 may be fed back to the host platform to improve the skills graph, virtual coach performance, and the like.

FIG. 1B illustrates an example of the skills certificate 140 that is created by the host platform 120 in FIG. 1A, in accordance with an example embodiment. Referring to FIG. 1B, the host platform 120 may populate the document with information 141 about the user such as the user's name, address, email address, phone number, etc. In addition, the host platform 120 may populate the skills certificate 140 with relevant employment history 143, relevant educational history, skills 145 obtained by the user, and the like. In addition, the host platform 120 may also add verification indicators 142, 144, 146, etc. within the skills certificate 140, indicating which skills and other attributes of the user have been successfully verified by the host platform 120 with a third party and which skills and other attributes have not been verified. In addition, in some cases, the host platform may add an identifier 147 which indicates that a skill is commonly held by people in that industry, without actually verifying that the user possesses that particular skill.

Although not shown in FIG. 1B, the skills certificate 140 may be embedded, enriched, augmented, or otherwise marked with additional content such as watermarks, codes, identifiers, images, and the like, for additional security and verification purposes.

The example embodiments may rely on a standardization of data referred to as the Occupational Information Network (“O*NET”) system, which is an online database that contains occupational definitions, including predefined codes assigned to different job titles and predefined fields/attributes assigned to each job title. In addition to job titles, the O*NET system also provides a list of skills associated with each job type. At present, there are around 1,000 predefined job titles, and more than 40,000 alternate titles, in the O*NET database along with skills/attributes of each. The O*NET database is continually updated with occupation information (e.g., on a quarterly basis, etc., as mentioned above).

The example embodiments may rely on O*NET job codes, or the like, that are assigned to different occupations and use these job codes as a way to map data within the host platform. For example, an ingested job history or skills history of a user may be mapped to a predefined O*NET job code or set of codes. This mapping, which may include processing to filter, combine, order, weight, or otherwise augment the job history and/or skills history, may then be used to query additional web-based services for additional information (e.g., via API calls, etc.), such as for the purposes of validation of the ingested job history. The queried/returned data can be added to the skills certificate, and it can be processed by machine learning models for other analysis.

In some embodiments, the skills certificate may be issued by a blockchain network that is managed via a distributed network of blockchain peers. The peers may be associated with a same organization, such as the same organization as the host platform 120 described in FIG. 1A. As another example, different entities (including untrusting and/or untrusted entities) may join the blockchain network and participate in the management of the underlying blockchain ledger, depending on embodiment, policies, etc. The parties may establish predefined agreements about how and when data is committed to the blockchain ledger. The agreements may be codified into chaincode (e.g., deployed blockchain smart contracts, etc.), which may be initiated on some or all of the blockchain peers. The chaincode may manage functions such as reading from the blockchain ledger, writing to the blockchain ledger, endorsing blockchain transactions, committing blocks to the blockchain, and the like.

FIG. 1C illustrates an example of a recommendation 150 output by the virtual coach 125 of the host platform in FIG. 1A, in accordance with an example embodiment. The recommendation may include a user name 151 and a list of job types 152 with attributes of each job type relevant to the user's current set of skills and earnings. For example, the skills gap may be used to represent a difference between the user's current set of skills and anticipated skills needed for the next job type. In some cases, the order of the recommended job types may be based on user preferences for factors such as earnings, geographical location, types of skills needed, etc. Although not shown in FIG. 1C, the recommendation 150 may include multiple work type recommendations, one or more recommended skills to obtain, and the like. The virtual coach 125 may also provide supporting information such as links to external sites, and additional information about acquiring the recommended skills. In the example of FIG. 1C, the recommendation 150 is broken down by job types, skills gap, and estimated earnings. In addition, the recommendation 150 may include other attributes such as skills still needed by the user for obtaining the necessary skills for the recommended job types, and the like.

According to various embodiments, an artificial intelligence/machine learning service (e.g., a virtual coach, etc.) may provide users with custom recommendations for future employment and career paths based on their skills, work experience, related information, and needs. This methodology and service can help a user regardless of where they are in their career journey, by combining their current employment, skills, education, certification, and related information with a large, machine-learning-based skills graph. The service is designed to help a user get onto a desirable career trajectory and improve over time, and it may include data from external sources, from user communities, and the like.

As further described herein, a “work type” or “job type” is an aggregated entity across location and employer at the job title level. Examples include “Barista”, “Sales Associate”, “Warehouse Worker”, “Delivery Driver”, or the like. This label or attribute can be used for downstream machine learning, as well as custom and automated analysis. Work types can be used in an O*NET or similar lookup service or datastore and can be related by skills in the form of a graph. The graph can be materialized in a graph database like Neo4J, or built-in code, such as that provided by Apache Spark's GraphX library.

In the example embodiments, work types or job types may exist as nodes in the skills graph. Furthermore, the nodes may be interconnected with edges. In some cases, each node may include a respective edge between itself and each of the other nodes in the skills graph, however, embodiments are not limited thereto. The edges may be annotated with skills data that identifies a relationship between the skills associated with the two work types. For example, an edge between a first node corresponding to a first work type and a second node corresponding to a second work type may include skills data that identifies shared skills or co-occurring skills within the first and second work types. This information may be embedded within an edge between the first and second nodes. For example, the edge may identify how many skills are shared, the names of the skills, how difficult the skills are to obtain, etc. Moreover, it should be appreciated that the graph connectivity architecture can take many forms, for example so that work type nodes can be connected to skills nodes by edges, such that a first work type node would connect to its associated skills nodes with edges, instead of being directly connected to other work type nodes by edges of the types mentioned above. In this example embodiment, the connections would be (first work type node)—(skill)—(second work type node), and so on. Naturally, many graph architectures are possible, as will be explored further below.

In some embodiments, the edges can be weighted differently and dynamically. These weights could be numerical values for earnings, how common each associated skill is, how difficult or expensive it is to obtain those skills, etc., and they may reflect nuances in particular roles that may be less common. Edges can be directed or undirected in different embodiments.

Examples of skills include physical abilities, programming in Python, cash register handling, operating heavy machinery, and the like. In some embodiments, relationships can be identified between individual skills that co-occur across work types. For example, a “skill cluster” may refer to a grouping of co-occurring skills into a larger unit that can provide additional aggregated information.

Finding employment can be a full-time job in the current rapidly changing job market. With ongoing automation rendering previous lines of work obsolete, a general recent shift in companies to focus on more skills-based hiring, and the recent Covid-19 pandemic creating major disruption to in-person work environments, many workers are being driven to discover alternative employment opportunities. The ability to find work both relevant to individual needs and sufficient for financial stability is harder than ever.

One approach to helping people navigate the difficulties of job discovery is to provide personalized career counseling. Machine learning based recommendations can be combined with in-person and/or automated services that can give customized and data-driven suggestions to help individuals make important employment decisions. These recommendation systems can find, rank, and surface work types for workers that leverage their current skill sets and work-related background, empowering workers to know what their prospects are, how to bridge skills, educational, credentialing, and other gaps, and how to earn more with their existing or augmented skill sets, education, credentials, etc.

The skills graph described herein can be used by the machine learning service to provide recommended career paths, skills attainment, education attainment, credential attainment, and related suggestions, using machine learning algorithms on datasets derived from robust employment history data identifying users job requirements and experience, combined with a graph-based methodology linking work types by skills at scale. For example, a pipeline of several combined machine learning models may provide relevant information for determining the best option or a reasonable set of otherwise desirable options for a user. These recommendations can be provided directly to the user, a physical or virtual career coach, or the like.

The process may include collecting employment history data of a user which is to be used to directly tailor opportunities that fit a user's individual criteria. This data includes, but is not limited to, employer, industry, and job title. This data can be obtained in various ways, including, but not limited to user surveys to obtain the information, user-permissioned access to various data sources, such as their financial institution data and payroll accounts, job history information extracted from third-party data sources, such as the Bureau of Labor Statistics, LinkedIn, and/or employment verification systems (e.g. Equifax, Experian, and/or TransUnion). In some cases, the data may be obtained/queried from a large skills database that connects to standardized work types and ML-driven skills clusters based on skill relationships, which may include various weights or other annotations indicating values associated with particular skills to facilitate combinations or other aggregations, as well as edge directions within the graph, in the case of directed graphs.

The skills graph includes a network of work types (nodes) linked by shared skills (edges) and skill clusters that form a mathematical graph object about which ML algorithms can estimate and predict patterns to make informative recommendations for workers seeking to employ their unique skills. The nodes and/or edges in this mathematical graph object may include various weights or other annotations indicating values associated with particular work types, skills, or other information to facilitate combinations or other aggregations. In some embodiments, the ML system may learn individual skill values and can predict the expected wage for any given skill profile, location, and education level. Furthermore, a feedback system may obtain user and/or coach feedback to help the system learn and improve over time. For example, a recommendation that is accepted may be sent back to the system to reinforce the model. As another example, a recommendation that is not accepted may be sent back to the system to retrain the model and remove that possible recommendation.

In the skills graph, individual job titles may belong to broad categories of work called work types. A given work type has a set of general skills commonly used during completion of the required work. A given work type can share skills with other work types and also have skills that are unique to that work type. This network of work types linked by shared skills forms a mathematical graph object about which ML algorithms can estimate and predict patterns to make informative recommendations for workers seeking to employ their unique skills. Linkages between work types and skills can be weighted, based on a representation of some relevant value (e.g., monetary value, frequency of occurrence, importance, etc.), or unweighted. In the case of directed graphs, edge values can be different in each direction, depending on the embodiment.

The skills graph can help provide a user with relevant information through a variety of automated processes performed via a machine learning web service. The service may identify work types with high existing skills overlap that can be identified with minimal to no additional skill requirements, identify skills gaps between work types and the list of skills with which to acquire to transition to those job types, construct prioritized lists of jobs to consider and skills to acquire, when combined with edge weights based on value, and the like.

In addition to relationships between skills and work types, relationships can also be derived between skills themselves. These relationships can be derived by looking at co-occurrences between skills in work types and include identifying clusters of skills that provide more nuanced information to the user, including methodologies for grouping skills that are similar to each other into a single, representative skill cluster, as well as to group commonly co-occurring skills into a more informative group, potentially resulting in improved analytical output and understandability, among other possible benefits. A sample of representative ML-based examples includes unsupervised ML clustering to identify subsets of skills that are related both within and across a user's current work industry, and supervised ML clustering to help identify how new skills acquired through third parties or identified in employment history data fit into existing skills networks.

In some embodiments, a machine learning model may estimate the monetary value associated with possessing a particular skill. This estimate can give the user a better understanding of which skills to obtain, for example, based on which skills have more earning potential, either alone or in groups of skills. This estimate could then be factored into the cost-benefit analysis presented to a user by the virtual coach (e.g., via a mobile application, web application, etc.) to help them determine the best skills to gain, opportunities to pursue, and the like.

The virtual coach may be embodied in the form of a chatbot, an avatar, a series of instant messages, and/or the like. The virtual coach software program may be hosted by the host platform and may access the ML services described herein and provide output recommendations to the user via a user interface, such as a chat window. The virtual coach may identify improvements that a user can make to their set of skills and credentials to improve their chances of attaining the next/ideal job in their career ladder and output information about the improvements via a chat session, message session, display screen, or the like. Here, a user could interface with a smart app, chatbot, virtual coach, or the like. These processes can help the user understand what skills, education, certifications, and the like to move to the next step in their job ladder or career progression.

In addition to providing users with better knowledge for making decisions, monetary values for skills can also be used in ML algorithms with other skills data to make predictions for overall wages for particular jobs and/or work types. Relevant algorithms that can be used include but are not limited to the following:
Regression (e.g. Linear, Logistic, etc.)
Tree-based Models (e.g. Decision Trees, Random Forest, Gradient Boosting, AdaBoost, etc.)
Matrix Factorization Methods (e.g. Collaborative/Content-based filtering, factorization machines, etc.)
Neural Networks, of various levels of depth and complexity
Ensembles of two or more models

The results of these models can be used for a variety of purposes, including but not limited to
Weighting nodes and edges in graphical models
Ranking skills and work types
Helping users view and evaluate their collective skill sets
Decisioning processes, for example when choosing among available work type recommendations offered

Below is a table illustrating examples of possible work type rankings that could drive the recommendations for a user with a Waiter/Waitress work history:

TABLE 1

| Work Type | Skill Gap | Earnings | . . . | Ranking |
|---|---|---|---|---|
| Grocery Cashier | 0 | $15/hour | . . . | 1 |
| Personal Care | 3 | $19/hour | . . . | 2 |
| Worker | | | | |
| Food Prep Worker | 3 | $17/hour | . . . | 3 |

Using skill clusters, monetary values of skills, and work types that share a full or partial set of skills, the system can rank suggested work types in a way that is beneficial for users. Depending on the user's individual needs and preferences, these rankings can include prioritization based on existing skills and skill gaps, education, estimated potential earnings, and existing local job demand, among other considerations.

FIGS. 2A-2D illustrate a process of performing machine learning based on a skills graph in accordance with example embodiments. FIG. 2A illustrates a storage system 200 with an example of a predefined list of skills 202 for a Waiter/Waitress job type, a predefined list of skills 204 for a Mine Car Shuttle Operator job type, and a predefined list of skills 206 for a Food Prep Worker. In this example, the user is currently employed as a Waiter/Waitress. In this example, the predefined list of skills 202 for Waiter/Waitress has several overlapping/common skills with the predefined list of skills 204 for Mine Car Shuttle Operator and the predefined list of skills 206 for Food Prep Worker.

In particular, the Waiter/Waitress job type has all of the skills necessary for Mine Car Shuttle Operator except for “Driving Skills”. Thus, the skills gap between the Waiter/Waitress job type and the Mine Car Shuttle Operator job type is one skill, in the forward direction from Waiter/Waitress to Mine Car Shuttle Operator. Meanwhile, the Waiter/Waitress job type is missing three out of thirteen skills for Food Prep Worker. Thus, the skills gap is three, in the forward direction from Waiter/Waitress to Food Prep Worker. However, the gap in skills is not enough to indicate the best job opportunity to recommend to the user. A suboptimal recommendation based simply on skills gaps ignores factors such as the weight or impact of certain skills with respect to others for a particular field.

FIG. 2B illustrates a process 210 of a host platform 220, which includes a skills graph service 222 configured to build a skills graph, a machine learning service 224 composed of one or more machine learning models configured to read data from the skills graph and make predictions based thereon, and a virtual coach 226 that is capable of outputting an recommendations predicted by the machine learning service 224 to a user device 230. For example, the virtual coach 226 on the host platform 220 may output the predicted result to a user device 230 via a chatbot interface, or the like.

Here, the skills data used by the skills graph service 222 and/or the machine learning service 224 may be obtained from one or more data sources 212 which may be internal, external, third-party, online, etc. The machine learning service 224 may be configured to predict or otherwise determine an optimal job opportunity for the user based on the skills graph generated by the skills graph service 222. The output of the machine learning service 224 may be one or more recommended jobs such as shown in the user interface 260 of FIG. 2D, as well as skills gaps, recommended education to obtain, earning potential for different career, educational, and/or certification options, etc. The output may be fed to the virtual coach 226 which formats the predicted result into a chat message and displays the chat message to a user interface on the user device 230 such as a front-end of the host application. Here, the virtual coach 226 may be represented by a bot or avatar within the chat interface. In addition, feedback from the user or the virtual coach 226 (e.g., selected job types of interest, job types that are not of interest, etc.) may be fed back to the machine learning service 224 for updating/retraining the machine learning models and/or it may be fed back to the skills graph service 222 for use in updating the skills graph or otherwise optimizing the system.

The skills graph service 222 may receive a job type or set of job types from the user and dynamically build a new instances of a skills graph for the user, in response. The skills graph service 222 may generate/create nodes and store job type data in the nodes, and it may connect the nodes together using edges. The edges may be annotated or otherwise interacted with to store skills information shared between the two job types corresponding to the two nodes connected by the respective edge. Nodes may also be annotated or otherwise interacted with similarly.

FIG. 2C illustrates a process 250 of the machine learning service 224 querying the skills graph 240 and making a prediction to recommend a new job opportunity of interest to a user. In this example, the skills graph 240 is built based on a user's current job type (JT #0), which is a Waiter/Waitress. The skills graph service 222 may receive the user's current job type (JT #0) and identify all other job types among a predefined list of job types, such as defined by O*NET, or the like, with similar skills. In some embodiments, the identified jobs that are added to the skills graph 240 may employ a predetermined threshold of missing skills. For example, any recommendation where the user would need to obtain 5 or more skills may be prevented from being added to the skills graph 240, i.e. those job types could be pruned from the skills graph 240, although the same effect could likely be achieved with filtering processes and heuristics.

In FIG. 2C, three other job types (JT #1, JT #2, and JT #3) are added to the skills graph 240 as nodes 242. Likewise, an edge 244 is positioned in between each pair of nodes and includes skills data 246 therein which identifies shared/common skills between the pair of job types/nodes. The ML service 224 may query the graph, for example, using Apache Spark and associated libraries such as GraphX, a graph database such as Neo4J, or the like, and return results that can be input to a machine learning model embodied within the ML service 224.

The host platform may help the user understand what skills they are missing to achieve a new/different job type. FIG. 2D illustrates a user interface 260 that could be presented to a user, physical coach, virtual assistant, or the like. In this example, the user's current job title is Waiter/Waitress. Based on their skills, they could be presented with a ranked list of three job types in this hypothetical, illustrative example. First, the user could consider a role as a Grocery Cashier using their current skills, to obtain a role with an anticipated wage of $15/hour, without expecting to acquire additional skills to do so. Next, the user could consider a role in Personal Care, with an expected wage of $19/hour, but requiring the acquisition or evidence of three additional skills. Third, the user could acquire or show and/or validate evidence of three additional skills to obtain a role in Food Prep, with an anticipated wage of $17/hour. The user could either assess this set of recommendations themselves, or with the assistance and/or guidance of a physical or virtual coach.

In all of these cases, it is important to appreciate that the graph need not be limited to specific job types. For example, synthetic job types can be created as mixtures of job types, representing a user's career path, or as mixtures of job types, acquired skills, certifications, and the like, and represented as nodes and edges in the skills graph.

For example, a user could have a career path that includes 3 job types, and the skills from those job types could be aggregated, weighted, or the like, as well as combined with skills that the user has gained via certifications and training processes, to create a node with which to query for relevant jobs recommendations.

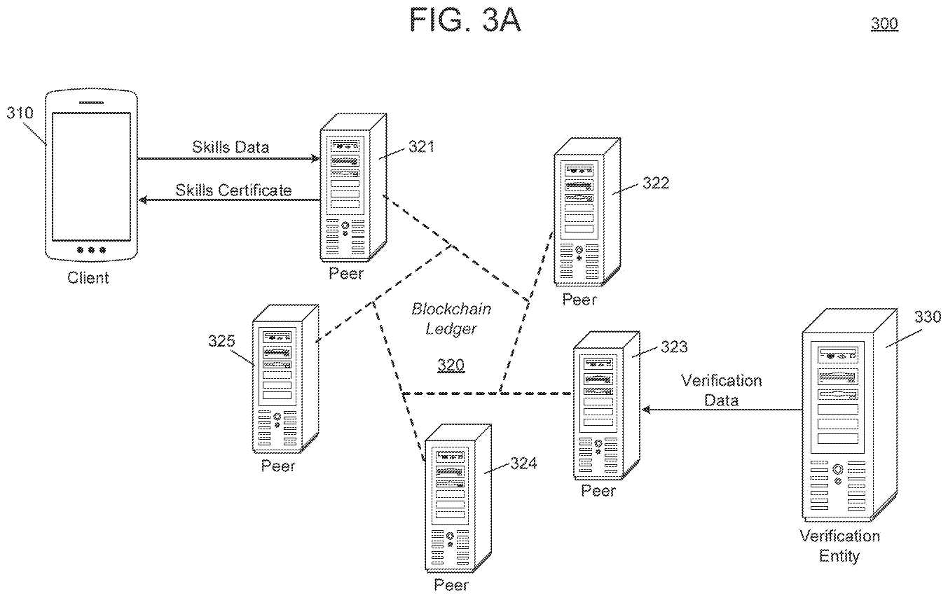

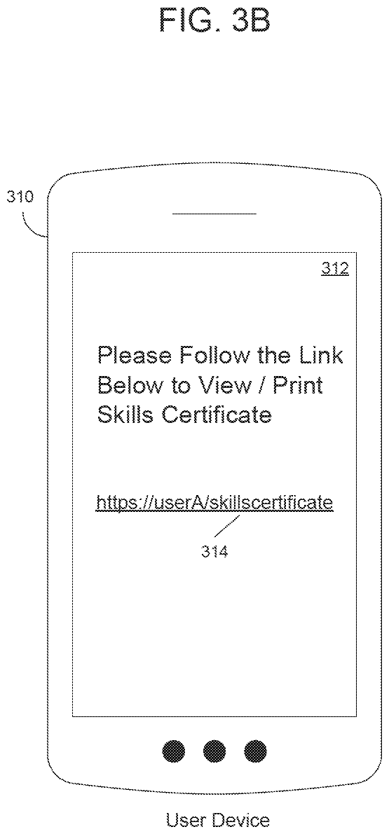

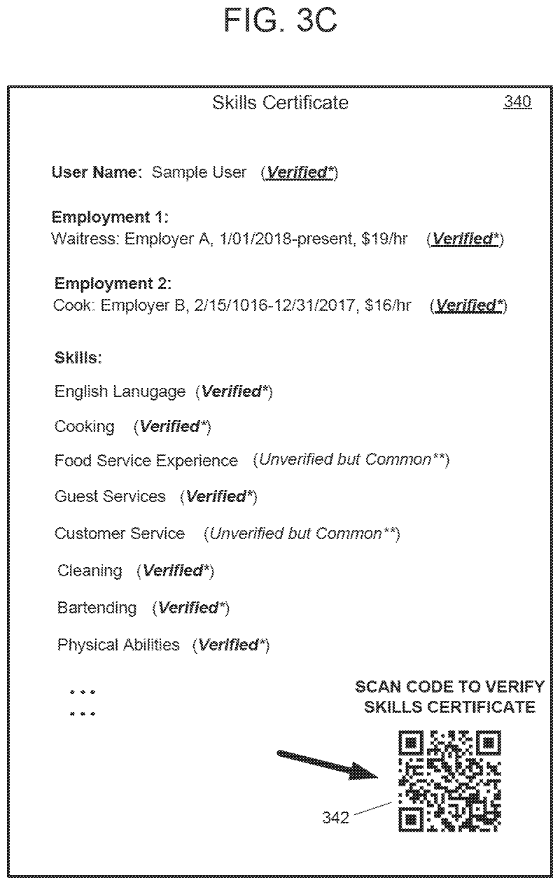

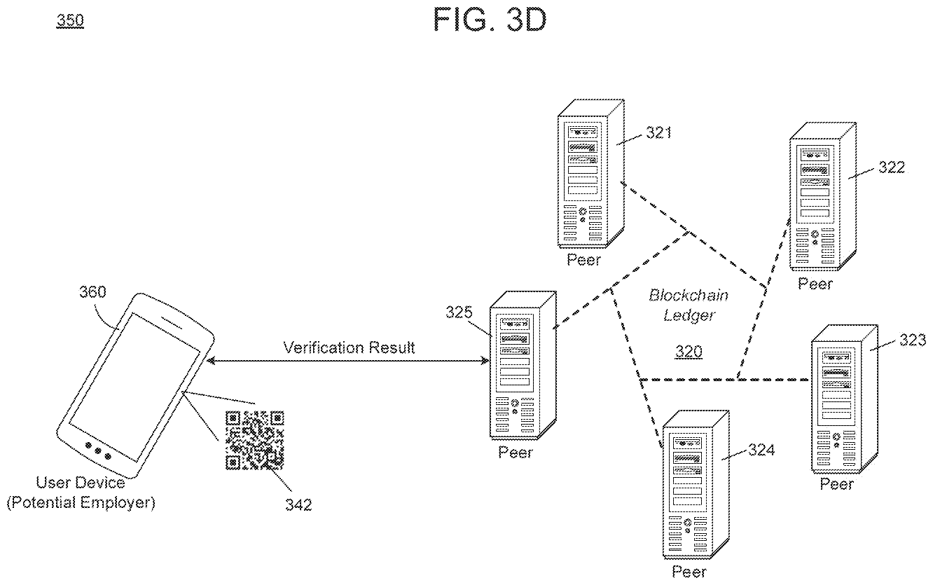

FIGS. 3A-3D illustrate a process of a blockchain network building a skills certificate and subsequently verifying an issued skills certificate in accordance with example embodiments. Referring to FIG. 3A, a process 300 is shown in which a client application 310 (e.g., blockchain client application) executing on a user device requests creation of a list of verified skills, which may or may not be output via a skills certificate.

Here, the client application 310 may be a client of a blockchain network that includes a plurality of blockchain peers 321-325 which manage a shared blockchain ledger 320. In this example, the plurality of blockchain peers 321-325 may be untrusting parties associated with different organizations such as a payroll processor, a financial institution, previous employers, and the like. As another example, the plurality of blockchain peers 321-325 may be different groups within a larger organization.

Prior to joining the blockchain network, the peers 321-325 may be required to agree to various skills generation and verification processes which are performed by the blockchain network. These processes may be embodied in the form of chaincode that is installed and running on each of the peers 321-325. The chaincode may be used to build a skills certificate, augment the skills certificate, verify the skills certificate, create a blockchain transaction with the skills certificate information and store it on the blockchain ledger 320, and the like.

However, the blockchain could be private, permissioned, or public, based on use case, sponsoring party, etc. An alternative that may be more appropriate in some cases and embodiments is to use a more traditional datastore.

FIG. 3B illustrates an example of an output to a user interface 312 of the client application 310. Here, a blockchain peer from the blockchain network shown in FIG. 3A, may include chaincode that outputs a user interface at a predefined URL associated with the client application 310. The blockchain peer may display a message on a user interface 312 along with a link 314 or some other identifier. Here, the user may click on the link 314 and open a skills certificate 340 as shown in FIG. 3C. Here, the skills certificate 340 includes a code 342, such as a QR code, numerical code, bar code, or the like, which can be scanned by a mobile device or other imaging equipment.

For example, the user may print out the skills certificate 340 or simply hold it up and show it to a potential employer in digital format, e.g. directly on a mobile device. In response, as shown in the process 350 of FIG. 3B, the employer can use their phone 360 or other device to scan the code 342. The scanning action may cause a signal to be sent to the blockchain network which is handled by a blockchain peer 325. In response, the blockchain peer 325 may identify the code, search the blockchain ledger 320 for corresponding details of the skills associated with such a code/user, and display a user interface on the device 360 of the employer that shows the user's verified skills to enable the employer to verify that the user has the requisite skills they are claiming they have.

In addition to the blockchain being used to store and verify a skills certificate, the blockchain may also be used for the skills graph recommendations to the user, physical/virtual coach, or the like, etc. For example, the decisions made by the virtual coach and the criteria used by the virtual coach to arrive at those decisions may be stored on a blockchain which could be a private, permissioned, or public blockchain, and tokens (e.g., ERC-20 fungible tokens, ERC-721 non-fungible tokens, aka NFTs, and the like) could be used as part of the blockchain implementation. For example, tokens may be issued each time a new recommendation is made, or NFTs could be minted for distinct skills certificates, however, embodiments are not limited thereto. The skills recommendation may be output in a similar fashion as shown in FIG. 3B, however, embodiments are not limited thereto.

The above embodiments may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

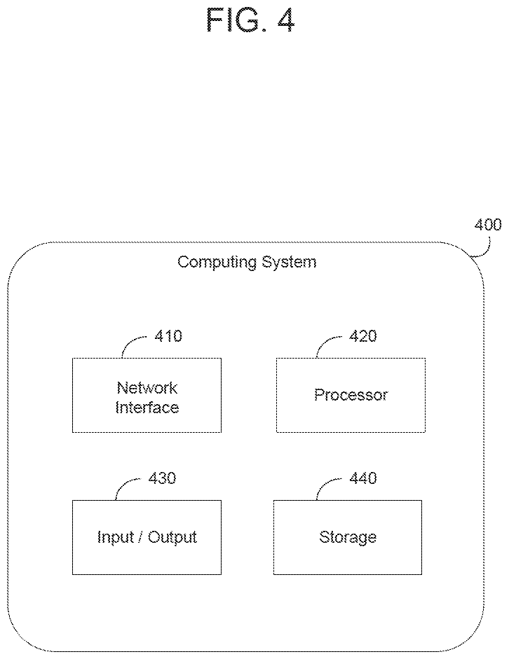

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 4 illustrates an example computing system 400 which may process or be integrated in any of the above-described examples, etc. FIG. 4 is not intended to suggest any limitation as to the scope of use or functionality of embodiments described herein. The computing system 400 is capable of being implemented and/or performing any of the functionality set forth hereinabove.

The computing system 400 may include a computer system/server, which is operational with numerous other general purpose or special purpose computing system environments or configurations. Examples of well-known computing systems, environments, and/or configurations that may be suitable for use as computing system 400 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, databases, and the like, which may include any of the above systems or devices, and the like. According to various embodiments described herein, the computing system 400 may be a tokenization platform, server, CPU, or the like.

The computing system 400 may be described in the general context of computer system-executable instructions, such as program modules, being executed by a computer system. Generally, program modules may include routines, programs, objects, components, logic, data structures, and so on that perform particular tasks or implement particular abstract data types. The computing system 400 may be practiced in distributed cloud computing environments where tasks are performed by remote processing devices that are linked through a communications network. In a distributed cloud computing environment, program modules may be located in both local and remote computer system storage media including memory storage devices.

Referring to FIG. 4, the computing system 400 is shown in the form of a general-purposecomputing device. The components of computing system 400 may include, but are not limited to, a network interface 410, a processor 420 (or multiple processors /cores), an output 430 which may include a port, an interface, etc., or other hardware, for outputting a data signal to another device such as a display, a printer, etc., and a storage device 440 which may include a system memory, or the like. Although not shown, the computing system 400 may also include a system bus that couples various system components including system memory to the processor 420.

The storage 440 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random-access memory (RAM) and/or cache memory. As another example, storage device 440 can read and write to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, storage device 440 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Although not shown, the computing system 400 may also communicate with one or more external devices such as a keyboard, a pointing device, a display, etc.; one or more devices that enable a user to interact with computer system/server; and/or any devices (e.g., network card, modem, etc.) that enable computing system 400 to communicate with one or more other computing devices. Such communication can occur via I/O interfaces. Still yet, computing system 400 can communicate with one or more networks such as a local area network (LAN), a general wide area network (WAN), and/or a public network (e.g., the Internet) via network interface 410. As depicted, network interface 410 may also include a network adapter that communicates with the other components of computing system 400 via a bus. Although not shown, other hardware and/or software components could be used in conjunction with the computing system 400. Examples include, but are not limited to the following: microcode, device drivers, redundant processing units, external disk drive arrays, RAID systems, tape drives, and data archival storage systems, etc.

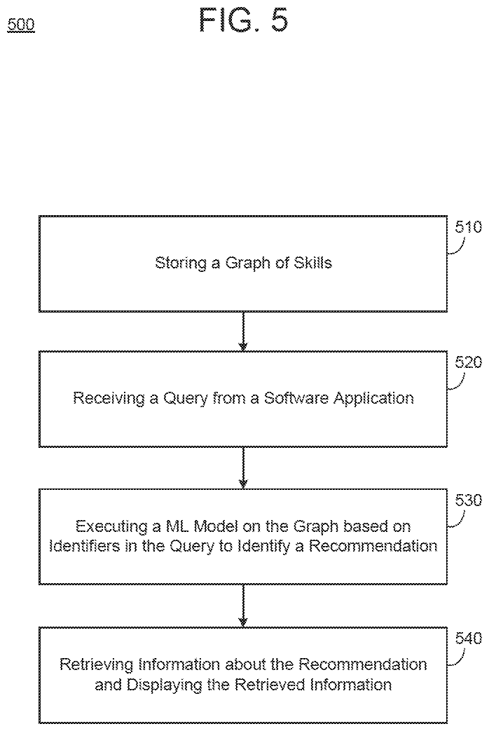

FIG. 5 illustrates a method 500 of generating a recommendation based on a skills graph in accordance with an example embodiment. For example, the method 500 may be performed by a host system such as a cloud platform, a web server, a database, a blockchain peer, a combination of systems, and the like. Referring to FIG. 5, in 510, the method may include storing a graph comprising a plurality of nodes corresponding to a plurality of job types and annotated edges that connect the nodes, wherein the edges are annotated with skills relationship data. The graph may be referred to herein as a “skills” graph because the nodes are interconnected with edges that identify skills-based relationships between the job types stored in the nodes. Moreover, among many other possible graph architectures, as described above, the plurality of nodes could correspond to job types and to skills, using edges to connect job type nodes via skill nodes.

In 520, the method may include receiving a query via a software application, wherein the query comprises an identifier of a job type and identifiers of one or more skills. In response to the query, in 530, the method may include executing a machine learning model on the graph based on the identifier of the job type and the identifiers of the one or more skills to identify a recommended job type. In 540, the method may include retrieving information about the recommended job type from the storage device and displaying the retrieved information on a user interface of the software application.

In some embodiments, the executing may include identifying a node in the graph that corresponds to the identifier of the job type, and identifying a second node in the graph that corresponds to the recommended job type via the machine learning model based on an annotated edge between the node and the second node in the graph. In some embodiments, the identifying may include identifying the second node based on identifiers of skills that are shared between the job type and the recommended job type which are stored in annotations on the edge between the node and the second node in the graph. In some embodiments, the identifying may include identifying a plurality of second nodes and select a second node corresponding to the recommended job type based on how many skills are shared between the job type and the recommended job type.

In some embodiments, the receiving may include receiving the query via a chat session between a virtual coach and the user, and the displaying comprises displaying a name of the recommended job type via the chat session with the user. In some embodiments, the method may further include receiving feedback about the recommended job type, and modifying one or more weights between nodes in the graph based on the received feedback. In some embodiments, the executing may include executing the machine learning model to identify a plurality of recommended job types and ranking the plurality of recommended job types based on skills data in the graph, and the retrieving comprises retrieving information about the plurality of recommended job types and displaying the retrieved information about the plurality of recommended job types based on the ranking. In some embodiments, the displaying may include displaying a plurality of identifiers of the plurality of recommended job types, and skills gap data for the plurality of recommended job types via the user interface.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs), and the like) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described regarding specific examples, it should be understood that various changes, substitutions, and alterations apparent to those skilled in the art can be made to the disclosed embodiments without departing from the spirit and scope of the disclosure as set forth in the appended claims.

1. A computing system comprising:
a storage device configured to store a graph comprising a plurality of nodes corresponding to a plurality of job types and annotated edges that connect the nodes, wherein the edges are annotated with skills relationship data; and
a processor configured to
receive a query via a software application, wherein the query comprises an identifier of a job type and identifiers of one or more skills;
in response to the query, execute a machine learning model on the graph based on the identifier of the job type and the identifiers of the one or more skills to identify a recommended job type; and
retrieve information about the recommended job type from the storage device and display the retrieved information on a user interface of the software application.

2. The computing system of claim 1, wherein the processor is configured to identify a node in the graph that corresponds to the identifier of the job type, and identify a second node in the graph that corresponds to the recommended job type via the machine learning model based on an annotated edge between the node and the second node in the graph.

3. The computing system of claim 2, wherein the processor is configured to identify the second node based on identifiers of skills that are shared between the job type and the recommended job type which are stored in annotations on the edge between the node and the second node in the graph.

4. The computing system of claim 2, wherein the processor is configured to identify a plurality of second nodes and select a second node corresponding to the recommended job type based on how many skills are shared between the job type and the recommended job type.

5. The computing system of claim 1, wherein the processor is configured to receive the query via a chat session between a virtual coach and the user, and display a name of the recommended job type via the chat session with the user.

6. The computing system of claim 1, wherein the processor is configured to receive feedback about the recommended job type, and modify one or more weights between nodes in the graph based on the received feedback.

7. The computing system of claim 1, wherein the processor is configured to execute the machine learning model to identify a plurality of recommended job types, rank the plurality of recommended job types based on skills data in the graph, retrieve information about the plurality of recommended job types, and display the retrieved information about the plurality of recommend job types based on the ranking.

8. The computing system of claim 7, wherein the processor is configured to display a plurality of identifiers of the plurality of recommended job types, and skills gap data for the plurality of recommended job types via the user interface.

9. A method comprising:
storing a graph comprising a plurality of nodes corresponding to a plurality of job types and annotated edges that connect the nodes, wherein the edges are annotated with skills relationship data;
receiving a query via a software application, wherein the query comprises an identifier of a job type and identifiers of one or more skills;
in response to the query, executing a machine learning model on the graph based on the identifier of the job type and the identifiers of the one or more skills to identify a recommended job type; and
retrieving information about the recommended job type from the storage device and displaying the retrieved information on a user interface of the software application.

10. The method of claim 9, wherein the executing comprises identifying a node in the graph that corresponds to the identifier of the job type, and identifying a second node in the graph that corresponds to the recommended job type via the machine learning model based on an annotated edge between the node and the second node in the graph.

11. The method of claim 10, wherein the identifying comprises identifying the second node based on identifiers of skills that are shared between the job type and the recommended job type which are stored in annotations on the edge between the node and the second node in the graph.

12. The method of claim 10, wherein the identifying comprises identifying a plurality of second nodes and select a second node corresponding to the recommended job type based on how many skills are shared between the job type and the recommended job type.

13. The method of claim 9, wherein the receiving comprises receiving the query via a chat session between a virtual coach and the user, and the displaying comprises displaying a name of the recommended job type via the chat session with the user.

14. The method of claim 9, wherein the method further comprises receiving feedback about the recommended job type, and modifying one or more weights between nodes in the graph based on the received feedback.

15. The method of claim 9, wherein the executing comprises executing the machine learning model to identify a plurality of recommended job types and ranking the plurality of recommended job types based on skills data in the graph, and the retrieving comprises retrieving information about the plurality of recommended job types and displaying the retrieved information about the plurality of recommended job types based on the ranking.

16. The method of claim 15, wherein the displaying comprises displaying a plurality of identifiers of the plurality of recommended job types, and skills gap data for the plurality of recommended job types via the user interface.

17. A non-transitory computer-readable medium comprising instructions which when executed by a processor cause a computer to perform a method comprising:
storing a graph comprising a plurality of nodes corresponding to a plurality of job types and annotated edges that connect the nodes, wherein the edges are annotated with skills relationship data;
receiving a query via a software application, wherein the query comprises an identifier of a job type and identifiers of one or more skills;
in response to the query, executing a machine learning model on the graph based on the identifier of the job type and the identifiers of the one or more skills to identify a recommended job type; and
retrieving information about the recommended job type from the storage device and displaying the retrieved information on a user interface of the software application.

18. The non-transitory computer-readable medium of claim 17, wherein the executing comprises identifying a node in the graph that corresponds to the identifier of the job type, and identifying a second node in the graph that corresponds to the recommended job type via the machine learning model based on an annotated edge between the node and the second node in the graph.

19. The non-transitory computer-readable medium of claim 18, wherein the identifying comprises identifying the second node based on identifiers of skills that are shared between the job type and the recommended job type which are stored in annotations on the edge between the node and the second node in the graph.

20. The non-transitory computer-readable medium of claim 18, wherein the identifying comprises identifying a plurality of second nodes and select a second node corresponding to the recommended job type based on how many skills are shared between the job type and the recommended job type.
